(19) United States
(12) Patent Application Publication
(10) Pub. No.: US 2026/0319953 A1
(43) Pub. Date: Oct. 15, 2026

(54) DYNAMIC PROGRAMMABLE CACHE MANAGEMENT

(71) Applicant: Think Silicon Research and Technology Single Member S.A., Rion Achaias (GR)

(72) Inventors: Chrysa KOKKALA, Patras (GR); Nikolaos MITAS, Patras (GR); Iakovos STAMOULIS, Patras (GR); Georgios KERAMIDAS, Patras (GR)

(73) Assignee: Think Silicon Research and Technology Single Member S.A., Rion Achaias (GR)

(21) Appl. No.: 19/354,220

(22) Filed: Oct. 9, 2025

Related U.S. Application Data
(63) Continuation of application No. PCT/GR2025/000007, filed on Mar. 28, 2025.
(63) Continuation-in-part of application No. 18/068,938, filed on Dec. 12, 2022, now Pat. No. 12,461,855.

(51) Int. Cl. G06F 12/0802

(52) U.S. Cl. CPC G06F 12/0802; G06F 2212/60

(57) ABSTRACT

A system and method for dynamic programmable cache management, executed by a processing-pipeline is presented. The method includes obtaining initial configuration and data requests from a compiler specifying types of data needed for processing tasks; analyzing real-time data usage patterns of each cache line to determine the actual data used; dynamically adjusting a cache line size based on the analyzed data usage; fetching, into a texture mapping unit (TMU) cache, required data from a texture memory based on the dynamically adjusted size of the cache line; rendering, by the TMU, the fetched data, wherein the TMU processes the fetched data by applying at least a transformation; and monitoring the cache line for fluctuations in data usage patterns.

### CROSS-REFERENCE TO RELATED APPLICATIONS

This application is a Continuation of International Application No. PCT/GR2025/000007 filed on Mar. 28, 2025, and a Continuation-In-Part of U.S. patent application Ser. No. 18/068,938, filed Dec. 20, 2022, which claims the benefit of International Application No. PCT/GR2022/000069, filed on Dec. 12, 2022, the contents of which are hereby incorporated by reference.

### TECHNICAL FIELD

The present disclosed subject matter relates to the memory of processing circuitry. More particularly, the present disclosed subject matter relates to cache memory management.

### BACKGROUND

Digital displays, integral to modern devices, encompass a range of technologies from Liquid-Crystal Displays (LCDs) and Light-Emitting Diode (LED) displays to advanced Organic Light-Emitting Diode (OLED) displays. Each supports high-definition visuals that demand substantial computational power and efficient memory management.

The core of digital display technology is the pixel, the basic unit of digital imaging. Modern high-definition displays, containing millions of pixels updated multiple times per second, facilitate smooth video playback and responsive application interfaces. However, managing these vast quantities of pixel data requires highly capable processing technologies that can swiftly manage and transmit large volumes of information from processors to displays.

Despite their two-dimensional nature, modern displays often simulate three-dimensional environments to align with human visual perception. This simulation is achieved through sophisticated processing techniques like texture mapping, which imbues two-dimensional surfaces with the illusion of depth. These processes are computationally intensive and consume significant memory bandwidth and power, especially when rendering complex scenes in real time.

Imaging computations, such as texture mapping, involve complex transformations such as rotations and scaling. These operations often necessitate accessing more data than needed due to the linear storage of data in memory caches, leading to inefficient memory usage. This inefficiency underscores the need for optimizing data handling to prevent unnecessary power consumption and memory bandwidth usage.

It would therefore be advantageous to provide a solution that would overcome the challenges noted above, specifically to enhance computational efforts and display technology by optimizing computational efficiency, memory usage, and memory access time, consequently improving power efficiency and performance, especially in battery-operated devices such as mobile phones and laptops.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include obtaining initial configuration and data requests from a compiler specifying types of data needed for processing tasks. The method may also include analyzing real-time data usage patterns of each cache line to determine the actual data used. The method may furthermore include dynamically adjusting a cache line size based on the analyzed data usage. The method may in addition include fetching, into a texture mapping unit (TMU) cache, the required data from a texture memory based on the dynamically adjusted size of the cache line. The method may moreover include rendering, by the TMU, the fetched data, where the TMU processes the fetched data by applying at least a transformation. The method may also include monitoring the cache line for fluctuations in data usage patterns. Other embodiments of this aspect include corresponding computer systems, apparatus, and computer programs recorded on one or more computer storage devices, each configured to perform the actions of the methods.

Implementations may include one or more of the following features. The method where dynamically adjusting cache line sizes further may include: calculating a maximum bytes used for each cache line and adjusting the size of the cache line accordingly. The method where the at least a transformation further may include any one of: scaling, rotation, resizing, projection of a texture onto a 3D model, distorting, and a combination thereof. The method where the initial configuration and data requests specify types of data needed, and where the initial configuration of cache lines is based on predetermined processing demands. The method where the analyzing of real-time data usage patterns may include: evaluating a bytes-used fields of each cache line, where the cache lines are segments of the texture memory adjusted dynamically in size based on the real-time data usage. The method where the a calculating of a maximum bytes of the cache line uses indicator bits. The method where the fetching is further guided by metadata annotations and indicator bits specifying the exact data to be fetched. The method where the monitoring is performed continuously by the processing-pipeline to ensure performance of the a dynamic adaptation of the cache line sizes. The method where continuous monitoring further may include: assessing an effectiveness of dynamic adjustments to cache line sizes based on short-term and long-term changes in data usage, and insights from data requests, monitoring tools, and runtime metrics are utilized to refine cache configurations. The method where dynamic adjustment of cache line sizes may include: reducing a size of a cache line in response to detecting that the a bytes-used field indicates that less data than allocated is utilized. The method where dynamic adjustment of cache line sizes further may include: increasing a size of a cache line in response to detecting that the a bytes-used field indicates that a majority of the allocated data is utilized. The method may include: storing a history of data usage patterns for each cache line; and adjusting a cache line size based on a prediction generated based on the stored history. The method where monitoring further may include: tracking an efficiency of data retrieval operations; and adjusting a cache configuration to minimize latency and maximize throughput. The method may include: configuring the texture mapping unit (TMU) to utilize a shader program to apply transformations to the fetched data, and where the shader program is adapted based on a type of transformation specified in a metadata annotation. The method may include: caching transformed data in the TMU cache for a subsequent rendering task that require similar transformations. The method where adjusting a cache line size further may include: initiating an adjustment in response to detecting a change in a data access patterns triggered by a software updates. The method may include: dynamically allocating cache lines to different threads based on real-time data usage patterns of each thread, where the processing-pipeline is configured to support a plurality of parallel processing threads. The method where continuous monitoring further may include: analyzing a data usage pattern utilizing a machine learning (ML) model; and generating a predictive adjustment to a cache line size based on a result of applying the ML model on the data usage pattern. The method may include: optimizing the dynamically adjusted cache line size based on a power consumption metric. Implementations of the described techniques may include hardware, a method or process, or a computer tangible medium.

In one general aspect, a non-transitory computer-readable medium may include one or more instructions that, when executed by one or more processors of a device, cause the device to: obtain initial configuration and data requests from a compiler specifying types of data needed for processing tasks; analyze real-time data usage patterns of each cache line to determine the actual data used; dynamically adjust a cache line size based on the analyzed data usage; fetch, into a texture mapping unit (TMU) cache, the required data from a texture memory based on the dynamically adjusted size of the cache line; render, by the TMU, the fetched data, where the TMU processes the fetched data by applying at least a transformation; and monitor the cache line for fluctuations in data usage patterns. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: obtain initial configuration and data requests from a compiler specifying types of data needed for processing tasks. The system may in addition analyze real-time data usage patterns of each cache line to determine the actual data used. The system may moreover dynamically adjust a cache line size based on the analyzed data usage. The system may also fetch, into a texture mapping unit (TMU) cache, the required data from a texture memory based on the dynamically adjusted size of the cache line. The system may furthermore render, by the TMU, the fetched data, where the TMU processes the fetched data by applying at least a transformation. The system may in addition monitor the cache line for fluctuations in data usage patterns. Other embodiments of this aspect include corresponding computer systems, apparatus, and computer programs recorded on one or more computer storage devices, each configured to perform the actions of the methods.

Implementations may include one or more of the following features. The system where the memory contains further instructions that, when executed by the processing circuitry for dynamically adjusting cache line sizes, further configure the system to: calculate a maximum bytes used for each cache line and adjusting the size of the cache line accordingly. The system where the at least a transformation further may include any one of: scaling, rotation, resizing, projection of a texture onto a 3D model, distorting, and a combination thereof. The system where the initial configuration and data requests specify types of data needed, and the initial configuration of cache lines is based on predetermined processing demands. The system where the memory contains further instructions that, when executed by the processing circuitry for the analyzing of real-time data usage patterns, further configure the system to: evaluate a bytes-used fields of each cache line, where the cache lines are segments of the texture memory adjusted dynamically in size based on the real-time data usage. The system where the a calculating of a maximum bytes of the cache line uses indicator bits. The system where the fetching is further guided by metadata annotations and indicator bits specifying the exact data to be fetched. The system where the monitoring is performed continuously by the a processing-pipeline to ensure performance of the a dynamic adaptation of the cache line sizes. The system where the memory contains further instructions that, when executed by the processing circuitry for continuous monitoring, further configure the system to: assess an effectiveness of dynamic adjustments to cache line sizes based on short-term and long-term changes in data usage, and insights from data requests, monitoring tools, and runtime metrics are utilized to refine cache configurations. The system where dynamic adjustment of cache line sizes further may include: reducing a size of a cache line in response to detecting that the a bytes-used field indicates that less data than allocated is utilized. The system where dynamic adjustment of cache line sizes further may include: increasing a size of a cache line in response to detecting that the a bytes-used field indicates that a majority of the allocated data is utilized. The system where the memory contains further instructions which when executed by the processing circuitry further configure the system to: store a history of data usage patterns for each cache line and adjust a cache line size based on a prediction generated based on the stored history. The system where the memory contains further instructions that, when executed by the processing circuitry for monitoring, further configure the system to: track an efficiency of data retrieval operations; and adjust a cache configuration to minimize latency and maximize throughput. The system where the memory contains further instructions which when executed by the processing circuitry further configure the system to: configure the texture mapping unit (TMU) to utilize a shader program to apply transformations to the fetched data, and where the shader program is adapted based on a type of transformation specified in a metadata annotation. The system where the memory contains further instructions which when executed by the processing circuitry further configure the system to: cache transformed data in the TMU cache for a subsequent rendering task that require similar transformations. The system where the memory contains further instructions that, when executed by the processing circuitry for adjusting a cache line size, further configure the system to: initiate an adjustment in response to detecting a change in a data access patterns triggered by a software updates. The system where the memory contains further instructions which when executed by the processing circuitry further configure the system to: dynamically allocate cache lines to different threads based on real-time data usage patterns of each thread, where the a processing-pipeline is configured to support a plurality of parallel processing threads. The system where the memory contains further instructions that, when executed by the processing circuitry for continuous monitoring, configure the system to: analyze a data usage pattern utilizing a machine learning (ML) model; and generate a predictive adjustment to a cache line size based on a result of applying the ML model on the data usage pattern. The system where the memory contains further instructions which when executed by the processing circuitry further configure the system to: optimize the dynamically adjusted cache line size based on a power consumption metric. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

In the drawings:

FIG. 1 is a schematic diagram of a processing-pipeline, in accordance with some disclosed embodiments;

FIG. 2 is a schematic illustration of a UV mapping scheme implemented on a TMU, in accordance with some disclosed embodiments;

FIG. 3 is a schematic illustration of an output bitmap generated by a texture mapping unit applying a rotation to an input bitmap, in accordance with some disclosed embodiments;

FIG. 4 is a flowchart of a method for utilizing a programmable cache line in texture mapping, in accordance with some disclosed embodiments;

FIG. 5 is a schematic diagram of a computing system with a memory reducing graphics processing-pipeline, in accordance with some disclosed embodiments; and

FIG. 6 is a flowchart of a method in accordance with some disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

One technical problem addressed by the disclosed subject matter is inefficient cache management, where commercially available caching mechanisms often fetch larger data blocks than necessary, anticipating the need for nearby data due to spatial locality. This can lead to inefficiencies, particularly when the additional data fetched is not utilized, resulting in wasted bandwidth and increased power usage that can degrade system performance, especially in scenarios where energy efficiency and bandwidth are critical.

Another technical problem addressed by the disclosed subject matter is static cache line sizing. Commercially available cache lines are sized without considering variable data access patterns, which do not adapt to the dynamic needs of modern applications and lead to suboptimal performance. This static approach inefficiently manages data-intensive tasks required by applications such as high-definition video processing or complex AI computational tasks, leading to persistent over-fetching that increases memory usage and power consumption, thereby reducing system effectiveness.

One technical solution provided by the present disclosure introduces a technique for dynamic programmable cache management within a microprocessor circuitry. In some embodiments, this method optimizes cache line sizes dynamically based on real-time monitoring of actual data usage patterns. It employs intelligent algorithms that adjust cache sizes on the fly, closely aligning cache operations with the needs of the application. For example, if a texture is rotated by a predetermined number of degrees, the programmable cache line is tailored to access from the cache memory only those bits that are required to render a specific line, ensuring that only the necessary data is read from memory, significantly reducing memory bandwidth usage. In some embodiments, this selective data retrieval process continues until an entire frame or object within a frame is fully rendered, enhancing efficiency and performance.

Another technical solution provided by the disclosure is static and dynamic configuration options. In some embodiments, configuration flexibility allows for static cache settings in environments with predictable data patterns, reducing the overhead associated with dynamic adjustments. In contrast, for unpredictable data access patterns, such as those found in graphics rendering, dynamic adjustments ensure optimal performance.

By minimizing unnecessary data fetching, the optimized cache management system substantially reduces power consumption and memory bandwidth usage, leading to faster processing times and reduced operational costs. This is particularly beneficial in battery-powered devices where energy conservation is crucial. Dynamic cache adjustment also enhances memory and power utilization, ensuring that these resources are not expended on unneeded data. This optimization improves application performance and extends battery life, thereby enhancing user experience across various platforms.

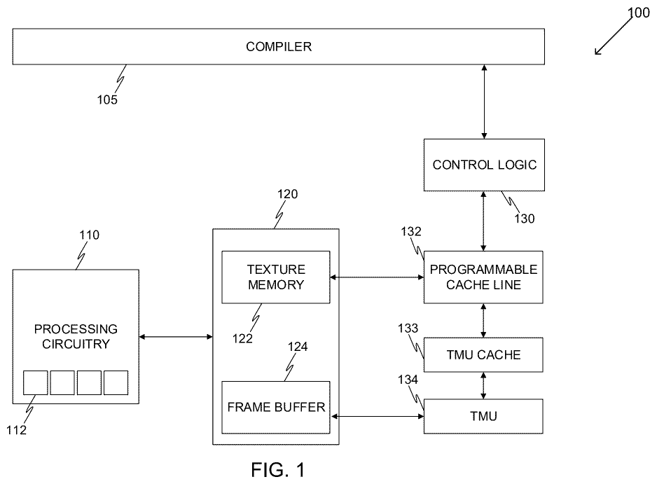

FIG. 1 is an example schematic diagram 100 of a processing-pipeline, implemented according to an embodiment. In an embodiment, a compiler 105 is implemented as a software application which is configured to receive a source code and generate a translation of the source code into machine code, bytecode, and the like, which is executable by the processing circuitry 110.

In an embodiment, the processing circuitry 110 includes a processing core 112. In certain embodiments, the processing circuitry 110 includes multiple processing cores. Each core is configured to process a single thread, multiple threads, and the like, according to an embodiment. In some embodiments, a processing circuitry 110 includes multiple cores, wherein a first group of processing cores share a first instruction set architecture (ISA) and a second group of processing cores share a second ISA. In some embodiments, the first ISA includes the second ISA. In certain embodiments, the first ISA and the second ISA are identical.

The processing circuitry 110 is realized in an embodiment as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), general purpose GPUs (GPGPUs), tensor processing units (TPUs), general-purpose microprocessors, microcontrollers, digital signal processors (DSPs), and the like, or any other hardware logic components that can perform calculations or other manipulations of information.

In an embodiment, the processing circuitry 110 is coupled to a memory 120. In some embodiments, the memory 120 is an on-chip memory, an off-chip memory, a scratchpad memory, a combination thereof, and the like. In an embodiment, the memory 120 includes a texture memory 122 and a framebuffer 124. In certain embodiments, the framebuffer 124 is implemented as a random-access memory (RAM). In some embodiments, the texture memory 122 is implemented as a non-volatile memory (NVM).

According to an embodiment, compiler 105 is configured to generate instructions for execution by a control logic 130. In an embodiment, the compiler 105 is configured to read code, which in an embodiment includes a metadata annotation indicating to translate a texture stored in the texture memory 122 and determine a number of bits to read from the texture memory 122 into a texture mapping unit (TMU) cache 133 to be read into a TMU 134. In certain embodiments, the TMU 134 is configured to generate an output written to the framebuffer 124. In some embodiments, the metadata annotation is generated at runtime and provided to any one of the compiler 105, the TMU 134, a combination thereof, and the like.

For example, in an embodiment the compiler 105 is configured to generate an instruction for execution by a control logic 130, which when executed by the control logic 130, configures the control logic 130 to utilize a programmable cache line 132 to read a predetermined amount of data (e.g., a number of bits) from the texture memory 122 into a texture map unit (TMU) cache 133. In an embodiment, compiler 105 is configured to predetermine the number of bits which need to be read.

In an embodiment, the programable cache line 132 is a cache memory which includes a plurality of bytes, each addressable by a unique address. In some embodiments, the programmable cache line 132 has a size of 128 bytes, 256 bytes, 512 bytes, or 1,024 bytes. In some embodiments, the programmable cache line 132 size is determined by an indicator bit, a plurality of indicator bits, and the like. For example, an indicator bit value of ‘00’ indicates a size of 128 bytes, an indicator bit value of ‘10’ has a 512-byte size, and the like.

In some embodiments, the indicator bit value indicates an address for data which should be read. For example, a memory in which a texture is stored is a block-addressable memory. In an embodiment, the indicator bit value indicates that data should be read from a block at a specific address associated with the block. For example, in an embodiment, an indicator bit value of ‘101’ indicates that data should be read from the second block of the memory, from bytes 128 to 256.

In certain embodiments, the programmable cache line 132 is configured to read a predetermined number of bytes from a texture memory 122 at an address. In an embodiment, the address is received from compiler 105. The programmable cache line 132 is configured to supply the bytes read from the texture memory 122 to a texture mapping unit (TMU) 134 by writing data into a TMU cache 133.

In an embodiment, the TMU 134 is a circuitry configured to rotate, resize, distort, project, and the like, a bitmap image onto a predetermined model, such as a three-dimensional model. In some embodiments, a TMU 134 is configured to receive an input including data representing a plurality of pixels. In some embodiments, a place in a data structure indicates a corresponding place on a display. In an embodiment, the TMU 134 is configured to receive data of a first pixel and a change instruction and determine a placement of the first pixel based on the change instruction.

In an embodiment the change instruction includes a rotation, a resizing, a distortion, a projection, a combination thereof, and the like. In an embodiment, data of a first pixel includes 8 bits representing a red channel, 8 bits representing a green channel, 8 bits representing a blue channel, 8 bits representing an alpha channel, a combination thereof, and the like.

In some embodiments, a position of a pixel is determined based on a place of bytes representing the pixel in a memory. For example, data of the first pixel is stored by the first 24 bits of a memory, according to an embodiment. In some embodiments the TMU 134 is configured to generate an output which includes data representing a pixel which is generated as a result of a change instruction. In an embodiment, the TMU 134 is configured to supply the output to the framebuffer 124.

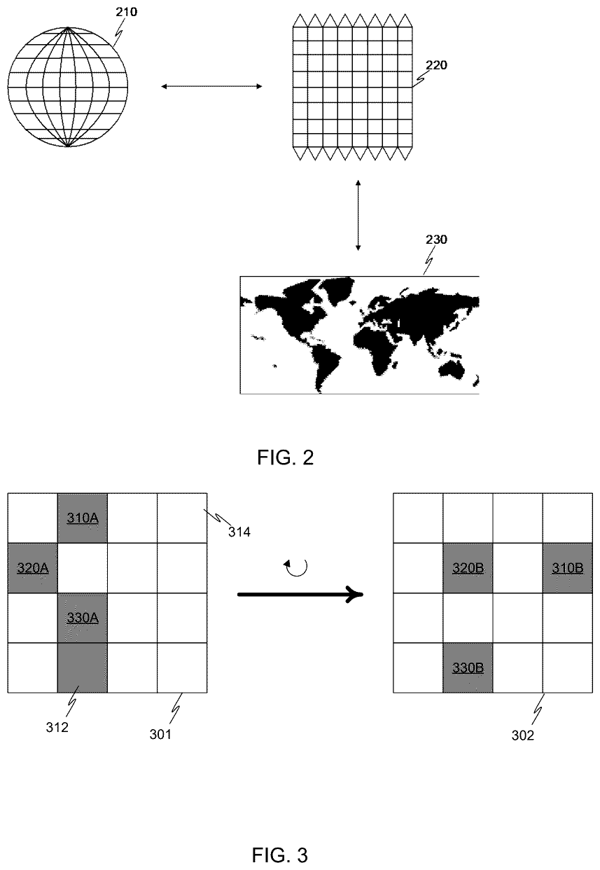

FIG. 2 is an example schematic illustration of a UV mapping scheme implemented on a TMU, utilized to describe an embodiment. A three-dimensional model 210 (also referred to as 3D model 210) includes a surface representation. For example, the three-dimensional model 210 includes a surface representation of a sphere. In an embodiment the 3D model 210 is represented by a polygon mesh. A polygon mesh is a data structure which includes vertices, edges, and faces which define a polyhedral object.

A texture map 230 is projected onto the 3D model 210. In an embodiment the texture map 230 is a bitmap stored in a memory. For example, in an embodiment the first 24 bytes of data describe a first pixel, the second 24 bytes of data describe a second pixel, etc.

In order to project the texture map 230 onto the 3D model 210 a mapping is performed between the texture map 230 to a UV map 220 according to an embodiment. In an embodiment the UV map 220 is a two-dimensional representation of the three-dimensional model 210.

In some embodiments, a texture mapping unit, such as the TMU 134 of FIG. 1 above is configured to receive a texture map 230, determine a UV map 220 of a three-dimensional model 210, and generate an output which includes values for generating a pixel of the UV map 220, such that each pixel in the UV map 220 is generated based on at least a pixel of the texture map 230.

FIG. 3 is a schematic illustration of an output bitmap generated by a texture mapping unit applying a rotation to an input bitmap, implemented in accordance with an embodiment. In an embodiment, a bitmap represents an image. For example, according to an embodiment a bitmap 301 includes a plurality of pixels, such as a first pixel 312 and a second pixel 314. In an embodiment, each pixel of the plurality of pixel includes a value. For example, in a binary representation the value of the first pixel 312 is ‘1’ to indicate the pixel should be colored black and the value of the second pixel 314 is ‘0’ to indicate that the pixel should be colored white.

In some embodiments, a plurality of bits is utilized to represent the color of a single pixel. For example, in an embodiment each pixel of a bitmap is represented by eight bytes, which are equal to 64 bits. In some embodiments, an image is represented by a plurality of bitmaps, each bitmap corresponding to a different color (e.g., a red channel bitmap, a green channel bitmap, a blue channel bitmap, an alpha channel bitmap, a combination thereof, and the like).

In an embodiment, the bitmap 301 is provided to a texture mapping unit (TMU) with an instruction to perform a rotation on the bitmap 301. When performing a rotation, the TMU is configured to read the bitmap image from a memory, perform the rotation to generate an output 302, and transfer the output 302 to a framebuffer. In an embodiment a TMU is configured to read a bitmap utilizing a cache line, a programmable cache line, and the like. That is, a bitmap is not read all at once, rather it is read line by line. However, for rotation, distortion, resizing, and the like, certain pixels of each line are utilized for the output, and some are not.

For example, the input bitmap 301 is resized and rotated such that a first rotatable pixel 310A is output as a first rotated pixel 310B, a second rotatable pixel 320A is output as a second rotated pixel 320B, and a third rotatable pixel 330A is output as a third rotated pixel 330B. In an embodiment, rotating a pixel includes storing at a predetermined address data of the pixel. In some embodiments, the address is predetermined by a compiler. For example, a compiler receives an instruction from a software program through an application programming interface (API) to read a texture into a texture cache, perform a change to the read data of the texture from the texture cache by a TMU, and store an output of the TMU in a framebuffer for displaying on a display, according to an embodiment. In other embodiments, the read data is further processed, for example, by a fragment shader, to generate a second output, which is stored in the framebuffer.

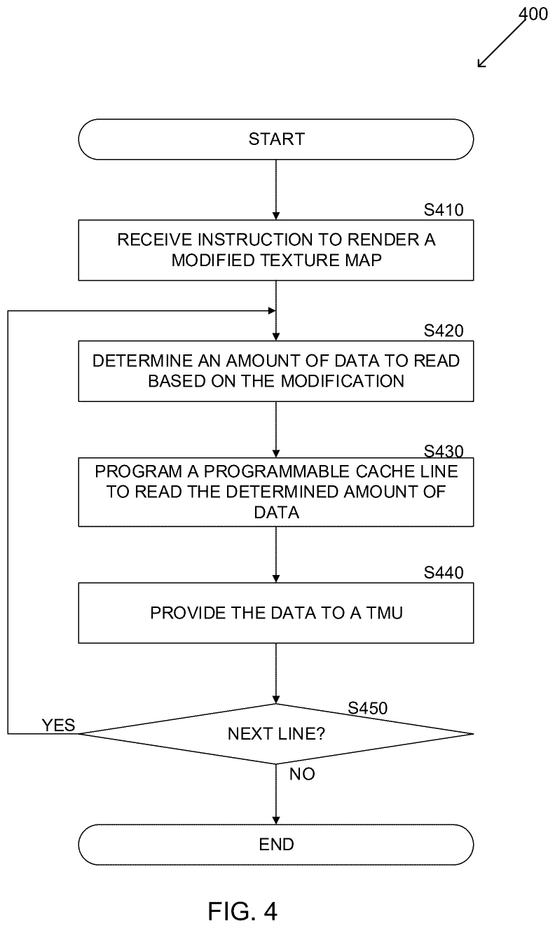

FIG. 4 is an example flowchart 400 of a method for utilizing a programmable cache line in texture mapping, implemented according to an embodiment. A programmable cache line allows to utilize less memory bandwidth when transferring data between a texture map memory and a texture cache. In some embodiments, the method is executed utilizing the architecture of FIG. 1 above, and specifically the programmable cache line 132 between the texture memory 122 and the TMU cache 133, which is connected to the TMU 134. This allows utilizing the memory for other purposes, implementing a processing circuitry with less memory, a combination thereof, and the like.

At S410, an instruction is generated to render a modified texture. In an embodiment the instruction includes a location in a memory, storage, combination thereof, and the like, where a texture is stored. In some embodiments, the location is an address in a memory. In some embodiments, the texture is a bitmap. In certain embodiments, the texture includes a plurality of bitmaps. For example, according to an embodiment each of the plurality of bitmaps corresponds to a unique channel. A channel is, according to an embodiment, a red channel, a green channel, a blue channel, an alpha channel, a combination thereof, and the like.

In some embodiments, the modified texture is a texture that is rotated, stretched, contracted, a combination thereof, and the like. In some embodiments, the modification is a transformation. For example, according to an embodiment, the transformation is defined by a matrix which, when applied to the texture, results in a new image which is different from the input image (i.e., the texture).

In an embodiment, the transformation is an affine transformation. An affine transformation is a geometric transformation which preserves lines and parallelism in an image. For example, scaling reflection, rotation, shearing, and the like, are all affine transformations. In some embodiments, a plurality of modifications is received, and an order in which to perform them. In an embodiment applying a modification, transformation, combination thereof, and the like, includes generating a multiplication, convolution, and the like, between an input matrix representing the texture, and a matrix representing the transformation, modification, and the like.

In certain embodiments the instruction includes a degree of rotation. A degree of rotation is represented, in an embodiment, by a value, a list of values, a rotation matrix, a combination thereof, and the like.

At S420, the amount of data is determined based on the degree of rotation. In an embodiment, the amount of data is a number of bits. In some embodiments the number of bits is a number representing a number of bits which are utilized by a TMU to generate an output for providing to a framebuffer memory for rendering a line, a portion of a line, and the like, in a display.

For example, based on a degree of rotation it is determined that from the first line of a texture map the first three pixels are needed to render a first line in a framebuffer. In an embodiment, each pixel is represented by 24 bits, therefore 72 bits of information need to be read from a memory storing therein the texture.

In some embodiments, an amount of data is determined which is equivalent to a number of bits. For example, an amount of data is, according to an embodiment, a number of bytes, a number of blocks, a number of bits, a combination thereof, and the like.

In certain embodiments, a first number of bits is determined for a first line of the texture, and a second number of bits is determined for a second line of the texture, wherein the bits of the second line of the texture are stored consecutively in a first line of the framebuffer after the bits of the first line of the texture.

At S430, a programmable cache line is configured to read the amount of data. In an embodiment, the programmable cache line is further configured to read a number of determined bits from an address of a memory containing therein a texture map.

In some embodiments, the programmable cache line is configured to read a number of bits which is at least as many bits as the determined number of bits. For example, according to an embodiment a programmable cache line is configured to be 64 bytes, 128 bytes, 256 bytes, and the like.

In an embodiment, where the determined amount of data is equal to 72 bytes, the programmable cache line is configured to read 128 bytes. Configuring the programmable cache line to read 64 bytes of data would be insufficient, configuring the programmable cache line to read more than 128 bytes would be redundant as the additional bytes beyond the first 72 bytes would not be used in the framebuffer at this stage. It is therefore advantageous to bring the least number of bytes that would still include the required 72 bytes.

In some embodiments, the programmable cache line is configured to read an amount of data predetermined by a compiler, such as discussed in more detail in FIG. 1 above.

In certain embodiments, configuring a programmable cache line to fetch a predetermined amount of data includes setting an indicator bit value of the programmable cache line to a value selected from a list of values. Each value corresponds to a unique predetermined amount of data, according to an embodiment. For example, setting the indicator bit value to ‘00’ configures the programmable cache line to read 64 bytes of a memory storing a texture map, setting the indicator bit value to ‘01’ configures the programmable cache line to read 128 bytes of the memory, etc., in accordance with an embodiment. In an embodiment the programmable cache line is further configured to read a number of bits from a specific address. For example, an indicator bit is set, according to an embodiment, to a value which indicates a specific address and a specific amount of data to read from the specific address. In certain embodiments, a first indicator bit is set to a first value which indicates an address, and a second indicator bit is set to a second value which indicates an amount of data.

In some embodiments setting an indicator bit value includes writing the value to a predetermined memory address which when read by a control logic of the programmable cache line, configures the programmable cache line to read a predetermined amount of data from a memory.

At S440, the data is provided to a texture mapping unit (TMU). In an embodiment, an amount of data is periodically determined, and data corresponding to the amount of data is read, for each period an amount is read from a different line (e.g., during the first period an amount of data is read from a first line, during the second period an amount of data is read from a second line, etc.). In certain embodiments, this is performed until a full line of data is read, which is used to populate a full line of a framebuffer which is connected to the TMU.

For example, in an embodiment 72 bytes of data are read from the first line of a texture map and provided to the TMU, followed by 32 bytes of data read from the second line of the texture map and provided to the TMU, followed by 8 bytes of data read from the third line of the texture map and provided to the TMU, etc.

In an embodiment, the TMU writes the data to a framebuffer in the order at which the data is received. For example, in the example discussed above, the 72 bytes of data would be written first (i.e., to the first address), the next 32 bytes of data are written to second (i.e., to the next address after the last address of the 72 bytes), and the 8 bytes would be written third (i.e., written to the next address after the last address of the 32 bytes).

At S450, a check is performed to determine if data should be read from another line of the texture map. In an embodiment, determining if another line should be read includes determining an amount of data written to the framebuffer, determining a size of the framebuffer, and initiating another read cycle in response to determining that the size of the framebuffer is larger than the amount of data written to the framebuffer.

If ‘yes’ execution continues at S420, otherwise execution terminates, according to an embodiment. In an embodiment, when a frame is written to a framebuffer, data is read from the framebuffer, and a display is configured to display an image based on the read data. In some embodiments a framebuffer includes sufficient memory to store a plurality of frames. For example, in double buffering a single framebuffer stores a current frame in a first portion of the framebuffer, and while the current frame is rendered a next frame is written into a second portion of the framebuffer. In an embodiment, the framebuffer then switches the first and second portions, so the second portion is displayed while the first portion is written to.

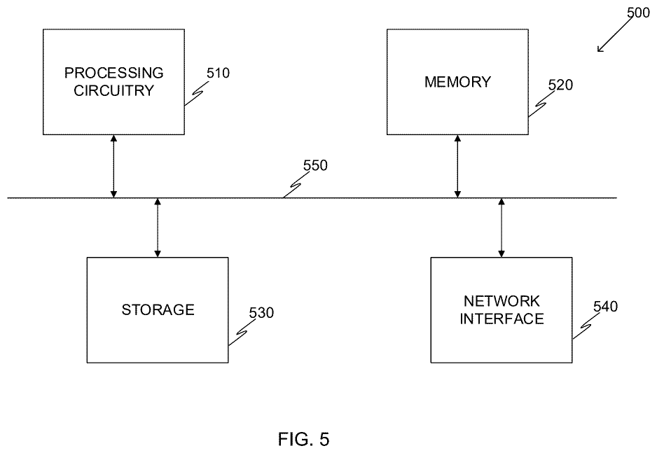

FIG. 5 is an example schematic diagram of a computing system 500 with a memory reducing graphics processing-pipeline, implemented according to an embodiment. The system 500 includes a processing circuitry 510 coupled to a memory 520, a storage 530, and a network interface 540. In an embodiment, the components of the system 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In an embodiment the processing circuitry 510 includes the processing circuitry 110, the control logic 130, the programmable cache line 132, the TMU 134, a combination thereof, and the like, of FIG. 1 above.

The memory 520 may be volatile (e.g., random access memory, etc.), non-volatile (e.g., read only memory, flash memory, etc.), or a combination thereof. In an embodiment memory 520 includes the memory 120, texture memory 122, framebuffer 124, a combination thereof, and the like, of FIG. 1 above.

In one configuration, software for implementing one or more embodiments disclosed herein may be stored in storage 530. In another configuration, memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

It should be understood that the embodiments described herein are not limited to the specific architecture illustrated in FIG. 5, and other architectures may be equally used without departing from the scope of the disclosed embodiments.

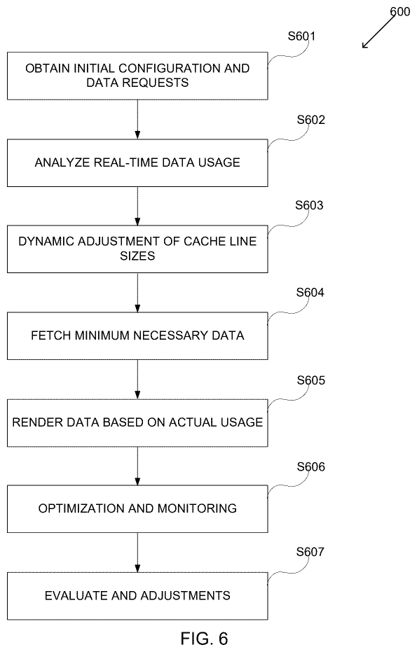

FIG. 6 is an example flowchart 600 of a method for dynamic programmable cache management, implemented in accordance with some disclosed embodiments. In an embodiment, the method 600 leverages the capabilities of the processing-pipeline (FIG. 1) to dynamically adapt to data usage patterns. In some embodiments, the method 600 is utilized to enhance the efficiency of high-performance applications, particularly those involving intensive graphics processing and AI. By enabling this adaptability, the method 600 aims to improve responsiveness and processing speed, which are critical for real-time data processing and complex computational tasks.

At S601, initial configuration and data requests are obtained. In some embodiments, the processing-pipeline (FIG. 1) is configured to receive data requests from the compiler 105 (FIG. 1) specifying the types of data needed (e.g., textures for graphics rendering), and is further configured in certain embodiments to log each request. It should be appreciated that data requests serve as the trigger for the process, specifying what data to fetch and how to process it. In an embodiment, these requests are often accompanied by metadata annotations generated by a compiler 105 (FIG. 1), which specify the required amount of data to be fetched from the texture memory 122. In some embodiments, the initial configuration of cache lines, which provides a starting point for cache operations before dynamic adjustments are made, is set to standard sizes, such as 32 or 64 bytes, based on a predetermined processing demand.

In an embodiment, the processing-pipeline (FIG. 1) includes processing circuitry 110, memory 120, programmable cache line 132, TMU 134, and control logic 130, which work together to execute method 600. In some embodiments, the processing-pipeline (FIG. 1) is configured to establish a baseline for cache operations, ensuring efficient handling of predictable data patterns. Furthermore, the programmable cache line 132 (FIG. 1) is initialized to prepare for runtime adaptations, in an embodiment.

At S602, real-time data usage is analyzed. In some embodiments, the processing-pipeline (FIG. 1) is configured to utilize a monitoring tool within the control logic 130 (FIG. 1) to continuously analyze data access patterns. These tools evaluate the bytes-used field of each cache line, tracking which portions of the fetched data are actively accessed during processing by the TMU 134 (FIG. 1). In some embodiments, a cache line is a segment of memory dynamically adjusted in size, playing a central role in efficiently fetching and storing the required data. In an embodiment, these monitoring tools drive the analysis and adjustments of cache line sizes, ensuring the system continuously aligns cache operations with real-time data usage.

In some embodiments, analyzing data patterns identifies actual data needs in real-time, providing critical insights for dynamically adjusting cache line sizes. This step minimizes unnecessary data retrieval, reduces power consumption, and optimizes memory bandwidth usage.

```
# Initialize the maximum bytes used
bytes_used_max= max_value # reset value
# On each cache line replacement
for each line in cache:
  # Reset the byte usage count for the current line
  bytes_used_cnt[line]= 0
  # Count the number of bits set to 1 in the bytes_used array for
the current line
  for each bit in bytes_used[line]:
    if bit == 1:
      bytes_used_cnt[line]+= 1
# Determine the new maximum bytes used
if max(bytes_used_cnt)< bytes_used_max:
  bytes_used_max= max(bytes_used_cnt)
else:
  # Attempt to increase the size
  bytes_used_max= max_value if max_value else bytes_used_max+ 1
# Compute the new cache line size
new_line_size= 2 \hat{ } ceil(log2(master_width_bytes bytes_used_max))
```

At S603, cache line sizes are dynamically adjusted. In some embodiments, the following computation algorithm is implemented to dynamically adjust the cache line sizes.

The maximum bytes used (bytes_used_max) are calculated for each cache line based on real-time monitoring, and the size (new_line_size) is adjusted based on these observations, either increasing or decreasing it dynamically. Indicator bits are then used in the programmable cache line 132 to adjust the cache line size (e.g., 128, 256, 512 bytes) based on runtime data access patterns.

The following table demonstrates a practical example of dynamic cache line size adjustments based on real-time data access patterns. In this example, the request at address 0x0600 shows a cache line size reduced to 8 bytes. This reflects the system's ability to dynamically adjust the size of the cache line when the system detects that fewer bytes are consistently being accessed. In this case, the “Bytes used” field, with a value of 0x0100, indicates that only 8 bytes were needed, prompting the system to reconfigure the cache line size to 8 bytes, thereby conserving memory bandwidth and power consumption.

Similarly, the request at address 0x400 displays a cache line size of 16 bytes, with a “Bytes used” value of 0x0010. This suggests moderate usage of the fetched data and results in the cache line being maintained at 16 bytes. At address 0x300, the cache line size remains at 32 bytes because the observed data access patterns justify keeping the line size at this larger value. Here, the “Bytes used” value of 0x0001 indicates more extensive data usage compared to the smaller lines.

These exemplary embodiments demonstrate how adjustments to the programmable cache line are configured using indicator bits, which determine the appropriate size based on observed data access. For instance, at address 0x600, the indicator bits configure the line to fetch only 8 bytes. At addresses 0x400 and 0x510, the cache line fetches 16 bytes, while at address 0x300, it retains the full size of 32 bytes. This process starts with an initial cache line size of 32 bytes and dynamically decreases or increases the size depending on usage patterns.

In some embodiments, method 600 employs real-time monitoring, using the “Bytes used” field to analyze which portions of the fetched data are accessed. When fewer bytes are used, the cache line size is reduced, as seen at 0x600. Conversely, if a sizable portion of the cache line is utilized, such as at 0x300, the size remains unchanged or is adjusted upwards in some embodiments.

TABLE 1.1

| | | Bytes | Bytes | Bytes | Bytes | Bytes | Line |
|---|---|---|---|---|---|---|---|
| Varid | Tag | 31-24 | 23-16 | 15-9 | 7-0 | used | Size |

| | | | |
|---|---|---|---|
| 1 | 0x400 | 0x0010 | 16 |
| 1 | 0x510 | 0x0001 | 16 |
| 1 | 0x600 | 0x0100 | 8 |
| 1 | 0x300 | 0x0001 | 32 |

It should be appreciated that S603 of method 600 ensures the programmable cache line 132 (FIG. 1) dynamically adapts to real-time demands, minimizing unused data while maintaining system performance in certain embodiments.

At S604, the minimum necessary data is fetched. In some embodiments, only the required data from the texture memory 122 (FIG. 1) is fetched into the TMU cache 133 (FIG. 1). This operation is guided by the adjusted size of the cache line and ensures that data retrieval aligns precisely with processing needs. In some embodiments, the programmable cache line 132 (FIG. 1) facilitates selective fetching based on the specific bytes indicated by the metadata annotations and indicator bits.

At S605, data based on actual usage is rendered. In some embodiments, the TMU 134 (FIG. 1) is configured to process the fetched data based on its designated tasks, such as rotation, resizing, projection, a combination thereof, etc., of textures onto 3D models. The TMU 134 (FIG. 1) is configured to apply transformations to the data as specified by metadata annotations provided by the compiler 105 (FIG. 1) and is further configured to output the results to the framebuffer 124 (FIG. 1). It should be appreciated that accurate rendering of textures is ensured while maintaining alignment with dynamically optimized cache operations.

At S606, the performance of the cache line is continuously monitored. In some embodiments, performance analysis involves examining both historical and current data usage patterns to fine-tune cache operations. This monitoring process includes, in an embodiment, upsizing cache lines, downsizing cache lines, a combination thereof, etc., in response to changes in access patterns. In some embodiments, the processing-pipeline (FIG. 1) is configured to ensure efficient processing across various operational conditions by dynamically adapting to fluctuations in data needs, thereby sustaining optimal performance and resource utilization.

At S607, the dynamic adjustments to cache line sizes are evaluated. In an embodiment, dynamic adjustments to cache line sizes are periodically evaluated for effectiveness through continuous monitoring, which assesses their alignment with both short-term and long-term changes in data usage. In some embodiments, insights gathered from data requests, monitoring tools, and runtime metrics are utilized to further refine cache configurations. Additionally, or alternatively, both static and dynamic settings may be adjusted as required to meet evolving system demands. In this step, the processing-pipeline (FIG. 1) is configured not only to ensure that the system adapts effectively to changing data usage patterns but also establishes a feedback loop that helps maintain operational efficiency, reduce costs, and enhance overall system stability.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A system for dynamic programmable cache management comprising:
a processing circuitry;
a memory, the memory containing instructions that, when executed by the processing circuitry, configure the system to:
obtain initial configuration and data requests from a compiler specifying types of data needed for processing tasks;
analyze real-time data usage patterns of each cache line to determine the actual data used;
dynamically adjust a cache line size based on the analyzed data usage;
fetch, into a texture mapping unit (TMU) cache, data required from a texture memory based on the dynamically adjusted size of the cache line;
render, by the TMU, the fetched data, wherein the TMU processes the fetched data by applying at least a transformation; and
monitor the cache line for fluctuations in data usage patterns.

2. The system of claim 1, wherein the memory contains further instructions that, when executed by the processing circuitry for dynamically adjusting cache line sizes, further configure the system to:
calculate a maximum bytes used for each cache line and adjusting the size of the cache line accordingly.

3. The system of claim 1, wherein the at least a transformation further comprises any one of:
scaling, rotation, resizing, projection of a texture onto a 3D model, distorting, and a combination thereof.

4. The system of claim 1, wherein the initial configuration and data requests specify types of data needed, and the initial configuration of cache lines is based on predetermined processing demands.

5. The system of claim 1, wherein the memory contains further instructions that, when executed by the processing circuitry for the analyzing of real-time data usage patterns, further configure the system to:
evaluate a bytes-used fields of each cache line, wherein the cache lines are segments of the texture memory adjusted dynamically in size based on the real-time data usage.

6. The system of claim 1, wherein calculating of a maximum bytes of the cache line utilizes indicator bits.

7. The system of claim 1, wherein the fetching is further guided by metadata annotations and indicator bits specifying the data to be fetched.

8. The system of claim 1, wherein the monitoring is performed continuously by a processing pipeline to ensure performance of dynamic adaptation of the cache line sizes.

9. The system of claim 8, wherein the memory contains further instructions that, when executed by the processing circuitry for continuous monitoring, further configure the system to:
assess an effectiveness of dynamic adjustments to cache line sizes based on short-term and long-term changes in data usage, and insights from data requests, monitoring tools, and runtime metrics are utilized to refine cache configurations.

10. The system of claim 1, wherein the memory contains further instructions that, when executed by the processing circuitry for dynamic adjustment of cache line sizes further configure the system to:
reduce a size of a cache line in response to detecting that a bytes-used field indicates that less data than allocated is utilized.

11. The system of claim 1, wherein the memory contains further instructions that, when executed by the processing circuitry for dynamic adjustment of cache line sizes further configure the system to:
increase a size of a cache line in response to detecting that a bytes-used field indicates that a majority of allocated data is utilized.

12. The system of claim 1, wherein the memory contains further instructions which when executed by the processing circuitry, further configure the system to:
store a history of data usage patterns for each cache line; and
adjust a cache line size based on a prediction generated based on the stored history.

13. The system of claim 1, wherein the memory contains further instructions that, when executed by the processing circuitry for monitoring, further configure the system to:
track an efficiency of data retrieval operations; and
adjust a cache configuration to minimize latency and maximize throughput.

14. The system of claim 1, wherein the memory contains further instructions which when executed by the processing circuitry further configure the system to:
configure the texture mapping unit (TMU) to utilize a shader program to apply transformations to the fetched data, and wherein the shader program is adapted based on a type of transformation specified in a metadata annotation.

15. The system of claim 1, wherein the memory contains further instructions which when executed by the processing circuitry further configure the system to:
cache transformed data in the TMU cache for a subsequent rendering task that require similar transformations.

16. The system of claim 1, wherein the memory contains further instructions that, when executed by the processing circuitry for adjusting a cache line size, further configure the system to:
initiate an adjustment in response to detecting a change in a data access patterns triggered by a software updates.

17. The system of claim 1, wherein the memory contains further instructions which when executed by the processing circuitry further configure the system to:
dynamically allocate cache lines to different threads based on real-time data usage patterns of each thread, wherein a processing pipeline is configured to support a plurality of parallel processing threads.

18. The system of claim 1, wherein the memory contains further instructions that, when executed by the processing circuitry for continuous monitoring, further configure the system to:
analyze a data usage pattern utilizing a machine learning (ML) model; and
generate a predictive adjustment to a cache line size based on a result of applying the ML model on the data usage pattern.

19. The system of claim 1, wherein the memory contains further instructions which when executed by the processing circuitry, further configure the system to:
optimize the dynamically adjusted cache line size based on a power consumption metric.

20. A non-transitory computer-readable medium storing a set of instructions for dynamic programmable cache management, the set of instructions comprising:
one or more instructions that, when executed by one or more processors of a device, cause the device to:
obtain initial configuration and data requests from a compiler specifying types of data needed for processing tasks;
analyze real-time data usage patterns of each cache line to determine the actual data used;
dynamically adjust a cache line size based on the analyzed data usage;
fetch, into a texture mapping unit (TMU) cache, data required from a texture memory based on the dynamically adjusted size of the cache line;
render, by the TMU, the fetched data, wherein the TMU processes the fetched data by applying at least a transformation; and
monitor the cache line for fluctuations in data usage patterns.
